(19) United States
(12) Patent Application Publication
(10) Pub. No.: US 2026/0220421 A1
(43) Pub. Date: Jul. 30, 2026

(54) CO-OPTIMIZING EVALUATIONS AND SELECTION OF MACHINE LEARNING MODELS

(71) Applicant: HEWLETT PACKARD ENTERPRISE DEVELOPMENT LP, Spring, TX (US)

(72) Inventors: TARUN KUMAR, Bangalore (IN); CONG XU, Singapore (SG); SUPARNA BHATTACHARYA, Bangalore (IN); MARTIN FOLTIN, Fort Collins, CO (US); ARPIT SHAH, Bangalore (IN)

(21) Appl. No.: 19/194,298

(22) Filed: Apr. 30, 2025

(30) Foreign Application Priority Data
Jan. 30, 2025 (IN) 202541007953

(51) Int. Cl. G06N 3/042

(52) U.S. Cl. CPC G06N 3/042

(57) ABSTRACT

Systems and methods are provided for co-optimized recommendation and evaluation of models, such as foundation models. Users may specify, in a natural language query, a request for (or requirements) regarding one or more models for application to a given use case. The query can be characterized along with models of a model repository to determine the suitability of models to satisfy the query. Benchmarks of a benchmark repository may also be analyzed to determine their suitability to be used to properly test any recommended models. The recommended models can then be tested on the recommended benchmarks. The characterization and analysis of models and benchmarks can reduce the compute and time costs associated with manual/conventional model and benchmark selection for use in a downstream application.

### CROSS REFERENCE TO RELATED APPLICATIONS

This application claims the benefit of and priority to India Provisional Patent Application No. 202541007953, filed on Jan. 30, 2025, the contents of which are incorporated herein by reference in their entirety.

### BACKGROUND

The use of Artificial Intelligence (AI) or machine learning (ML) has become ubiquitous. Along with the ever-increasing use of AI/ML, the number of models that have been developed to support the use of AI/ML has commensurately increased, especially foundational models. Foundational models, also known as large X models (LxMs), are models that have been trained on massive datasets so that they can be applied across a wide range of use cases. Generative AI applications, such as large language models (LLMs) are a common example of foundational models. Because foundational models can be applied in many different contexts, they can be used as a basis for developing or deriving more specific or specialized models. Foundational models may have unique characteristics, associated training data, as well as performance profiles that are typically considered by users to determine whether or not one or more foundational models may be appropriate for their purposes, e.g., for use in their own applications, or for developing their own downstream models based on such foundational models.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates an example system architecture for model recommendation and benchmark evaluation in accordance with one example of the disclosed technology.

FIG. 2 is a computing component that may be used to determine potential models for evaluation in accordance with one example of the disclosed technology.

FIG. 3 is a computing component that may be used to evaluate a model using a recommended benchmark.

FIG. 4 illustrates an example of generating benchmark recommendations in accordance with one example of the disclosed technology.

FIG. 5 is a schematic representation of a model evaluation process in accordance with one example of the disclosed technology.

FIG. 6 depicts a block diagram of an example computer system in which various examples of the disclosed technology described herein may be implemented.

The figures are not exhaustive and do not limit the present disclosure to the precise form disclosed.

### DETAILED DESCRIPTION

As noted above, the use of AI/ML technologies has become ubiquitous. The already large and growing number of foundational models that a user may consider to support such AI/ML technologies, the nature of foundational models (i.e., their ability to be used in many different contexts), and the breadth of their associated training data, makes assessing the characteristics and performance of such foundational models a complex issue.

Repositories of foundational models have been created that allow users to share foundational models, datasets, and natural language processing (NLP) transformers libraries, along with results/other metadata associated with foundational models. Such repositories can have on the order of 150,000 foundational models, with new foundational models being released at a rate of approximately 10,000 per month. The number of foundational models that already exist, and the rate of foundational model development, alone, make it infeasible for users to manually assess and select foundational models that are appropriate for their use case. Moreover, the assessment and selection of appropriate foundational models is multifaceted.

First, benchmarks (standards/reference points used to evaluate performance, capabilities, or metrics of a system against defined criteria) are used to test foundational models. Following the above example, testing, e.g., 150,000 foundational models on 100 benchmarks would result in 15 million evaluation runs. Manual/human evaluation would be impossible given this scale of testing. Even computer-based evaluation (as would be performed conventionally) would consume huge amounts of computational resources, and time. Second, users typically specify their respective foundational model requirements in natural language. This translates into a need for the sophisticated interpretation of such natural language due to the inclusion of implicit constraints, resource limitations, and other requirements, as well as a need to identify relevant benchmarks with which to assess foundational model performance. Third, existing benchmark results can be incomplete, and performance data can be fragmented across multiple platforms, making the decision process difficult due to, e.g., different evaluation conditions, especially in the case of newly-developed foundation models. For example, foundational model repositories can include model cards/direct users to articles or blogs regarding models and their performance. As another example, leaderboard platforms may contain foundational model performance data.

It should be noted that although examples of the disclosed technology are especially useful for assessing foundational models, examples of the disclosed technology can facilitate the assessment and selection of AI/ML models in general. Accordingly, examples of the disclosed technology are directed to systems and methods for recommending models and benchmarks for testing such recommended models, as well as evaluating the recommended models using the recommended benchmarks. In this way, one or more models that could potentially meet the needs of a user while minimizing evaluation costs can be discovered or identified, as well as identifying relevant benchmarks with which the performance of the identified models can be tested. Additionally, new model evaluation results can be incorporated into the recommender engine to improve future model recommendations.

In operation, a user query indicating model specifications/desired attributes/etc. is vectorized using both dense and sparse encoding, the results of which can be combined into a comprehensive query vector. That is, models can be represented by a hybrid characteristics vector that includes dense embeddings and sparse representations. Dense embeddings can be derived from model descriptions, e.g., past use cases, model cards (a document or artifact that summarizes model metadata, e.g., intended use, training data, performance metrics, etc.), research articles, and blogs associated with a model. Sparse representations can be derived from model metadata, domain-specific applications, and task category(ies) information. The similarity between the user query and models in a model space can be determined. The association strength/relevance of one or more models to the query can be determined based on that determined similarity to identify possible models that may be able to satisfy the user query.

As discussed above, potentially-relevant models can be tested or evaluated using benchmarks. Accordingly, the recommendation engine can match the requirements set forth/gleaned from the user query with the capabilities of available benchmarks. That is, the recommendation engine can determine which benchmarks the user should leverage in order to best test the identified models. Although benchmark repositories exist, benchmarks are not generally associated with summaries of their characteristics, past uses, etc. In other words, benchmarks do not have a corollary to a model card. Accordingly, benchmark topics (defined problems or datasets used to evaluate the performance of a model) can be extracted based on topic modeling of benchmark descriptions or samples from respective benchmark repositories. Benchmarks may be summarized based on the samples/descriptions/topics, and an LLM can be used to determine a benchmark's similarity to the user query, thereby identifying an initial set of recommended benchmarks. The initial set of benchmarks can be refined by calculating the semantic similarity between benchmark descriptions, sample-based summaries, and the user query, resulting in a final set of recommended benchmarks.

The identified models can be narrowed down to the most relevant for a given user query by computing σ_{model}(Qᵥ, C[Mᵢ]), i.e., the association strength of query vector, Qᵥ, with the characteristics of model, Mᵢ. A recommendation score for the “top” models (models determined to be most strongly associated with the user query) can be calculated according to Rec_{score}(Q, Mᵢ)=(α)σ_{model}(Qᵥ, C[Mᵢ])+ (1−α)Σ_{j∈B}_{_{rec}}σ_{benchmark}(Q, Bⱼ)*Pᵢⱼ, and those models with the highest recommendation score can be recommended by the recommendation engine.

Once one or more r models benchmarks have been identified/recommended, the recommendation engine may commence with evaluating the performance of the recommended models based on testing using the recommended benchmarks. That is, the recommendation can identify if any of the top models are missing any evaluations with respect to any of the recommended benchmarks, and if so, those models, Mᵢ, may be evaluated using the benchmarks, Bⱼ, to compute a performance matrix of that model(s), Pᵢⱼ=P(Mᵢ|Bⱼ) (the performance of model, Mᵢ, on benchmark, Bⱼ. It should be noted that this computed (now, updated) performance metric can be saved. Any subsequent evaluation of the model(s) based on the benchmark(s) can benefit from this evaluation, i.e., this newly/latest calculated performance metric can be used for calculating the recommendation score described above, Rec_{score}(Q, Mᵢ). In other words, if a model has not been previously evaluated or tested in accordance with a benchmark, that model's evaluation with respect to that benchmark is “missing,” whereas if the model has been previously evaluated using the benchmark, that previous evaluation can be used without having to re-evaluate the model.

Determining the top models and evaluating those top models can be iteratively performed to co-optimize both model recommendation, and benchmarked model evaluation. It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

It should also be noted that existing testing systems are not scalable to a level that could handle the number of models/benchmarks contemplated by the disclosed technology. Prior art systems generally handle model spaces of about 10 models, and most operate based on extensive, fine-grained, prompt-level training data that limit the applicability to a broader range of use cases. Aside from the logistical expense, and time cost of performing such prior art evaluations, manual selection of a subset of models to test based on metrics, such as popularity of use, can result in potentially missing a better-specialized model(s) that could satisfy a query. Additionally still, using, e.g., generic LLM routers that don't account for domain-specific requirements, will not result in the best/optimal results. As will be described in greater detail below, sparse encoding used to analyze a query, and model characterization takes aspects such as domain into account.

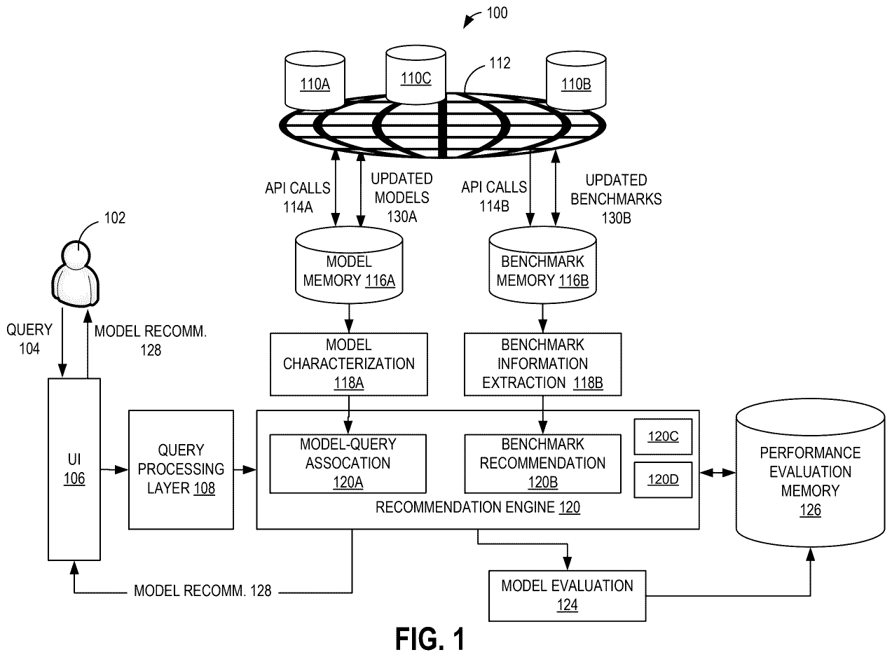

FIG. 1 illustrates an example system architecture of a model and benchmark recommendation and evaluation system 100. As noted above, a user 102 may have a task that he/she wishes to accomplish with the use of AI/ML. That task can be any task or job that can be performed through the use of a model, whether the model is applied directly to solving or processing the task or job, or whether the model (such a foundational model) is applied indirectly by using that model for some downstream application or function, e.g., as a basis for a downstream AI/ML model. User 102 may submit or input a query 104 that specifies desired characteristics of a model that user 102 would like to the model to have or exhibit for solving or processing the task or job. As noted above, query 104 may be submitted or input as a natural language query to user interface (UI) 106. UI 106 can be graphical or other UI that accepts queries as inputs, such as text, audio (which can be translated into text for vectorization, described in greater detail below), etc.

It should be noted that query 104 need not be limited to specifying the characteristics of just a single model. User 102 may have a desire to identify multiple models to solve/process a task, e.g, query 104 may specify a desire for a plurality of models that user 102 intends to apply sequentially. For example, user 102 may specify, via query 104, that he/she desires a model(s) for performing a particular type of prediction or analysis or analyzing a particular dataset type. User 102 may indicate in query 104 that the desired model(s) should comport with a particular ruleset, such as a compliance standard applicable to a dataset type.

Query processing layer 108 may comprise logic or a processing engine that transforms query 104 into a vector embedding representative of query 104. As is known by those skilled in the art, vector embeddings (also referred simply as vectors or as embeddings) can refer to numerical representations of data/objects that retain the “meaning” of the data, e.g., meanings of words, as well as relationships, in this case, between words that make up query 104. Vector embeddings (by virtue of being numerical representations) reduce data dimensionality, while still allowing important features of the data to be captured. The points (of a vector) identified in space may be semantically meaningful to models.

In some examples, query processing layer 108 vectorizes query 104 using a hybrid approach that involves performing both dense and sparse encoding to generate dense and sparse embeddings or vectors. Dense vectors can refer to numerical arrays that store elements (numbers) (typically in a contiguous block of memory), where typically, a value exists for every dimension, and where most of these values are non-zero. Dense vectors tend to have utility when the majority of the dimensions have valuable/meaningful information.

In contrast, sparse vectors can refer to numerical arrays that store only non-zero values and their corresponding indices, where elements or dimensions are zero (or assumed to be zero). Sparse vectors tend to be useful for highly dimensional data where much of the data may not have much meaning, or when seeking to identify or extract high-level context or more abstract contexts from the data.

Given the differences in the traditional use of dense and sparse vectors, examples of the disclosed technology achieve more fulsome representations of query 104 by considering both perspectives. For example, while a dense vector is able to capture much/all of the detail from the natural language of query 104, a sparse vector is able to capture more topical themes from the natural language of query 104. Query processing layer 108 may combine the dense and sparse vectors into a combined and comprehensive query vector.

As noted above, model repositories or platforms and benchmark repositories or platforms exist, where users can access models/benchmarks for their own use. Models and benchmarks may be stored or provided via the same or different repositories/platforms. An example model repository 110A can be accessed via the Internet 112 (or other data network), using, e.g., application programming instance (API) calls 114A, and the models maintained in model repository 110A can be persisted in model memory 116A while being characterized and associated with query 104. Similarly, a benchmark repository 110B may be accessed via the Internet 112 (or other data network), using, e.g., API calls 114B, and persisted in benchmark memory 116B. API calls, as understood by those skilled in the art, can refer to requests made by recommendation engine 120 to access models stored or maintained by model repository 110A. Because models are persisted in model memory 116A, the models can remain accessible (for evaluation purposes using a recommended bookmark(s)), and model evaluation results may also be persisted to be available for use by future recommendation operations. Persisting the models further allows for the ability to generate recommendations for more than a single/current use case. It should be noted that persisting the models in the context of examples of the disclosed technology can refer to persisting model identifiers along with model cards (other model-related metadata/information). That is, an actual model (code/data/file(s)) can be, e.g., several GBs in size, and because model repositories can, as noted above, host hundreds of thousands of models, downloading and storing actual models would be unfeasible. Likewise, when a model is recommended to a user, it is the model identifier that can be presented.

Referring to the persisted models in model memory 116A, as with query 104, the models can be characterized by a vector, where the vector can be a hybrid characteristic vector that combines both dense and sparse embeddings representative of respective models persisted in model memory 116A. In some examples, model characterization module 118A (which can be an engine or logic executed to perform such characterization) may perform this vectorization. Dense vectors of models can be generated from informational sources including model repository 110A (which may comprise, but is not limited to information, such as past use cases, model card, etc.) as well as other sources for model data, e.g., blogs, web articles, etc., collectively referred to as model data source 110C. Sparse vectors of models can be generated from metadata comprising information including, but not limited to model size, quantization methods, etc.), as well as other information such as domain-specific applications that leverage such models, categories of tasks to which models have been applied, and so on. That is, sparse vectors can be generated from, again, more generalized or topical information regarding models or model usage, whereas dense vectors can be generated from information that is specifically related to/regarding the models.

Based on these hybrid characterizations of the models persisted in memory 116A, model-query association module 120A (which can comprise an association engine or logic) can determine the strength of the relationship between the models persisted in model memory 116A and query 104. In this context, the association strength of a model to a query can be representative of how relevant or applicable a model may be to satisfying the query. For example, and as noted above, hundreds of thousands of models may exist in a model repository, such as model repository 110A. Some of those models may have been developed for a particular purpose, e.g., regression learning or image prediction. Some models may have been trained on a particular dataset(s). Some models may be known to have been used for a particular use case, and so on. Model-query association module 120A can be used to determine whether a model is relevant to (and therefore, possibly warranting recommending its use to satisfy) query 104.

As noted above, the association strength between a model and a query, e.g., query 104, can be represented as σ_{model}(Qᵥ, C[Mᵢ]), where the query can be represented by hybrid/comprehensive query vector, Qᵥ, with the characteristics, C, of model, Mᵢ, being represented by the expression, C[Mᵢ]. This association strength can be calculated using similarity calculations or techniques, such as cosine similarity. It should be understood that hybrid/comprehensive query vector, Qᵥ, can be used to improve the quality of the association strength determination/value by considering both dense and sparse encodings. That is, if, e.g., only dense embeddings were generated and used to determining association strength, the failure to extract sparse metadata used to generate a sparse representation, would likely result in the exclusion of one or more important aspects of a query that could provide context, or related perspective. Moreover, data science approaches can provide still further information with which association strength can be determined or assessed by obtaining or gleaning further information/characteristics of models, i.e., the characteristics of models can be extended or augmented with additional information/insight. For example statistical methods (e.g., co-occurrence matrices) can be used for identifying metadata-characteristics pairs that occur together. Another statistical technique, e.g., the log-likelihood ratio, can be used to eliminate metadata characteristics that are likely meaningless, e.g., the indication that a model is a foundational model. Lineage graphs can track data as it progresses through a model(s), provide base model details, training data information (source, owner, etc.), and so on. If a user query indicates a desire for a healthcare-specific foundational model, statistical methods such as those described above can further identify, e.g., a healthcare-medical characteristics pair that means the query vector (once generated) will not merely contain embedding information directed to “healthcare,” but also the term/idea of “medical.”

As also noted above, in addition to recommending models, benchmarks that can be used to test or evaluate models may be recommended. In this way, a co-optimization framework based on both model and benchmark recommendations/evaluations can be achieved, while minimizing the number of evaluations. That is, instead of testing, e.g., every model or some set of models of model repository 110A using every benchmark or some set of benchmarks, examples of the disclosed technology perform model-query association and benchmark recommendation operations or processes to reduce the number of candidate models/benchmarks that are to be tested/used for evaluating the candidate models. Thus, model-query association module 120A, along with benchmark recommendation module 120B (described in greater detail below) can make up recommendation engine 120.

Similar to the manner in which models are discovered (from model repository 110A), and persisted in model memory 116A, benchmarks can be obtained or accessed from benchmark repository 110B via the Internet (other data network) 112 using API calls 114B. These benchmarks can be persisted in benchmark memory 116B.

However, unlike models, benchmarks may not necessarily have information regarding their use or information providing their characteristics, etc. That is, benchmarks may not have associated benchmark cards like the manner in which models may be associated with or have model cards. Accordingly, in some examples of the disclosed technology, benchmark information can be extracted by a benchmark information extraction module 118B.

Benchmark information extraction module 118B may comprise some engine or logic configured or executed to obtain information that characterizes the benchmark so that benchmarks for evaluating models can be identified. In some examples, topic modeling can be performed to extract benchmark topics, which as discussed above, can refer to defined problems or datasets used to evaluate the performance of a model.

Topic modeling can refer to a form of statistical modeling (the use of mathematical expressions and statistical assumptions to generate sample data/make predictions) that uses unsupervised ML techniques to identify clusters or groups of similar words, in this context, words of query 104. By identifying such clusters or groups, semantic structures in query 104 can be identified and used to understand the meaning of query 104 without relying on predefined tags or training data from which the ML techniques would typically learn. It should be understood that a semantic structure can refer to parts of text (e.g., groups of words, characters that delineate textual sections, etc.) that can be used to define the intended meaning of natural language. Based on these topics, the benchmarks persisted in benchmark memory 116B, can be summarized to provide one manner of benchmark characterization, that along with the benchmark topics can be used to identify relevant benchmarks that can/should be used to evaluate the performance of models. Benchmark recommendation module 120B may comprise some engine or logic configured or executed to identify relevant benchmarks (based on benchmark topic modeling, benchmark summaries, etc.) that are suitable/relevant for evaluating models to ultimately satisfy query 104.

Again, recommendation engine 120 comprises model-query association module 120A and benchmark recommendation module 120B. From the results of model-query association (determined strength of association between models and query 104), and based on recommended benchmarks, recommendation engine 120 can determine a subset of the models persisted in model memory 116A to be recommended for use to satisfy query 104. In other words, recommendation engine 120 can be used to identify a refined set of models that are most-like/more-likely to satisfy query 104.

More particularly, for a given query, Q, the top (e.g., most promising/relevant models), M_{semantic}, can be identified by computing σ_{model}(Qᵥ, C[Mᵢ]), where M=[M₁, M₂, . . . , Mₘ] is a set of models, e.g., a set of models of model repository 110A/persisted in model memory 116A. Query, Q, can refer to the natural language query input by user 102, i.e., query 104, while Qᵥ corresponds to the query (comprehensive) vector embedding comprising a combination of dense and sparse embeddings representative of query 104. The term, C[Mᵢ], can represent the metadata characteristics of a model, M.

As discussed above, a recommendation score for the models of the set of models, M, can be calculated as Rec_{score}(Q, Mᵢ)=(α)σ_{model}(Qᵥ, C[Mᵢ])+ (1−α)Σ_{j∈B}_{_{rec}}σ_{benchmark}(Q, Bⱼ)*Pᵢⱼ. It should be noted that a can refer to a weighting that balances the semantic similarity of query, Q, with models, σ_{model}, and model performance on benchmarks, benchmark. Thus, σ_{benchmark}(Q, Bⱼ) can represent the suitability of benchmark, Bⱼ, to satisfy query, Q. The summation aggregates or adds up the respective performances of a particular model, i, on a recommended benchmark, j, e.g., if five benchmarks are recommended, a model's estimated performance is a summation of the performance of the model when tested or evaluated on the five benchmarks.

Models with the highest Rec_{score} can be recommended by recommendation engine 120, wherein one or more models to be recommended 128 can be forwarded by UI 106 to user 102. In some examples, the recommendation output is the name of a recommended model. In some examples, a threshold can be set to define which Rec_{score} values fall within the category of “highest” Rec_{score}. This can be a variable parameter or setting that can be defined by the user. A user, such as user 102 may wish to consider a specific number of models with the “highest” Rec_{score}, e.g., only the model with the highest Rec_{score} value, or only models with the highest fifteen Rec_{score} values are to be recommended. In other examples of the disclosed technology, the threshold may be based on an actual Rec_{score} value, e.g., only models whose corresponding Rec_{score} value is at/above a particular Rec_{score} value should be recommended by recommendation engine 120. Other thresholds or filters may be used/implemented to determine which models are to be recommended for satisfying query 104.

For example, and in practice, models that do not have an “acceptable” sparse vector similarity as discussed above may be removed from consideration. In other words, those models that do not fit into the constraints of a use case are dropped from getting recommended and further evaluation. For the remaining models, the number of characteristics crossing the threshold of cosine similarity between the dense embedding of model characteristics and the query can be assigned to associated with the models' respective association strength, σ_{model}(Qᵥ, C[Mᵢ]). If a model has already been evaluated on a given benchmark, a value or score can be assigned, but if not, the model is evaluated, and corresponding Pu values are obtained. This leads to computing the Rec_{score} of the model. The Rec_{score} for other models can be calculated, and those models with the highest Rec_{score} can be recommended. As described herein, determining a “highest Rec_{score},” can be achieved in a variety of ways, e.g., comparison to a defined threshold, determination of models having a particular (defined highest) Rec_{score}, and so on.

Once a set of models are identified to be evaluated (e.g., some subset of the models persisted in model memory 116A), the model(s) can be evaluated by model evaluation module 124 using the benchmark(s) recommended by benchmark recommendation module 120B. For example, upon recommendation engine 120 identifying a model for evaluation, the recommended model can be passed to model evaluation module 124. After evaluation/testing, the performance of a model, Mᵢ, on a benchmark, Bⱼ, i.e., Pᵢⱼ, can be persisted in performance evaluation memory 126. In this way, upon subsequent identification/recommendation of a model/benchmark, the performance of the model on a particular benchmark need not be recalculated/re-assessed, making recommendation of models potentially faster, and potentially with less compute cost. An ultimate/final recommendation comprising one or more models that have been recommended by recommendation engine 120 and evaluated by model evaluation 124 (along with their corresponding performance information) can be forwarded by recommendation engine to user 102. In some examples, that ultimate model recommendation can be forwarded by or through UI 106 (or other communication or display mechanism (not shown)). In some examples, user 102 may opt not to proceed with evaluation, simply choosing to rely on the models identified by recommendation engine 120.

It can be appreciated that recommendation engine 120 may use the performance matrix, Pᵢⱼ=P(Mᵢ|Bⱼ), in determining recommendation scores for candidate models. As described above, performance matrix, Pᵢⱼ, can be persisted in performance evaluation memory 126, and performance matrix, Pᵢⱼ, can be incrementally updated by model evaluation module 124. In this way, model recommendation and evaluation can be co-optimized, and model evaluation module 124 can focus on evaluating only the most promising <model, benchmark> pairs recommended by recommendation engine 120, which avoids a need for exhaustive evaluation procedures/computations.

Such co-optimization of recommending and evaluating models can be achieved with an objective function, where the objective is to: (1) maximize the relevance of recommended models to a query, e.g., query 104; (2) explore the set of models and identify those models for which further evaluation may be warranted to estimate their expected performance; and (3) exploit the refinement of candidate models identified by recommendation engine 120 by recommending those models that maximize expected performance on relevant benchmarks.

A balance between recommending models for evaluation (which can be an expensive process) and recommending models based on existing evaluations (which is associated with a risk of excluding better-performing models) can be obtained through such an objective function. An example of this objective function can be expressed as follows.

$$S *= {S ⊆ M}^{argmax} \{ β ( {\sum }_{i ϵ S} ( ( α ) {σ}_{model} ( {Q}_{v} , C [ {M}_{i} ] ) + ( 1 - α ) {\sum }_{j ϵ B} {σ}_{ben chm ark} ( Q , {B}_{j} ) * {P}_{ij} ) ) - ( 1 - β ) \vert S \vert \}$$

In the above objective function, S*, can refer to an optimal set of recommended models that maximizes the objective semantic similarity, as well as performance on benchmarks. S can refer to the subset of models selected from the set of models, M, for recommendation. |S| can refer to the size of subset, S. β can refer to a hyperparameter controlling the exploration (low β values) and the exploitation (high β values) trade-off. Again, this trade-off or balance is that between identifying more models that can be considered and minimizing the cost of model evaluation, maximizing the weighted sum, and minimizing the size of S, where β∈[0,1]. As already discussed above, α can refer to a weighting that balances the semantic similarity of query, Q, with models, σ_{model}, and model performance on benchmarks, σ_{benchmark}.

In other words, the objective function can be used to identify the subset of models, S, that maximizes the first quantity, β, while minimizing the size of S (corresponding to 1−β). For larger values of hyperparameter, β, many/more models can be recommended at the cost of more evaluations that are performed. While setting hyperparameter, β, at such a larger value, can reduce the chance of failing to identify a relevant model, it comes at the cost of an increased number of evaluations. In contrast, specifying a lower value for hyperparameter, β, can result in a more “conservative” approach, where fewer candidate models may be recommended (with high confidence that they are relevant to the query).

Within the first term of the objective function, weight, a, can be used to control the importance of semantic similarity of a particular use case to model metadata characteristics as opposed to that model's performance using a recommended benchmark(s). The value of weight, a, can therefore, be specified based on the availability and budget for evaluations. If the recommended models are well-evaluated on a recommended benchmark(s), and can be verified based on a trusted leaderboard with results of benchmark testing, a lower value of hyperparameter, a, can be specified to rely more on performance evaluation scores or values of the trusted leaderboard. It should be noted that a leaderboard can refer to a mechanism used by model repositories that provide insights/information into model capabilities and limitations. That is, leaderboards typically comprise platforms that rank models, such as LLMs, based on their performance against/across various evaluation benchmarks. In other words, if information regarding model performance exists, and can be trusted, reliance on recommendations provided by examples of the disclosed technology (which can incur costs) may be lessened, i.e., examples of the disclosed technology can be augmented with trusted performance information. Although the above objective function assumes exploring possible model subsets with evaluation benchmarks simultaneously, the above-described co-optimization of recommendation and evaluation provides a workaround to this simultaneous performance issue.

As noted above, model repositories and benchmark repositories can be continually updated with new (revised) models/benchmarks. In some examples, model memory 116A and benchmark memory 116B can be updated so as to provide user 102 with latest/complete-as-possible set of models and benchmarks to consider. That is, API calls 114A/114B can access and download for persisting, e.g., all/newly updated models and benchmarks to be considered by recommendation and evaluation system 100 in response to a query 104. In some examples, the information/data generated or gleaned by operation of recommendation and evaluation system 100 can be used to update a model repository (e.g., a model's model card/metadata, accuracy score, rtc.), a benchmark repository (e.g., benchmark metadata), or other data source (110A-110C).

Once the recommended model(s) has been evaluated by model evaluation module 124, that evaluation can be stored or persisted in performance evaluation memory 126. In some examples, key-value pairs can be used as a format for persisting performance information, e.g., performance information can be defined over model-benchmark pairs, and persisted in performance evaluation memory 126.

As noted above, such evaluations can be used as a basis for determining an ultimate set or subset of models that can be recommended to user 102 for satisfying query 104. For example, recommendation engine 120 may comprise, e.g., a processor 120C and memory 120D including computer code or instructions that when executed, cause processor 120C to filter performance evaluation information associated with models to determine the model(s) (post-evaluation) to recommend. Performance metric thresholds or score thresholds, and the like, can be used to determine which model(s) to recommend. As discussed above, when association strengths of models to the query are determined, users can opt to take those initial model recommendations without proceeding with benchmark evaluations, e.g., processor 120C, in accordance with instructions from memory 120D, can determine those models with a determined recommendation score, those models that meet/exceed as recommendation score threshold, etc., can identify or recommend models to user 102.

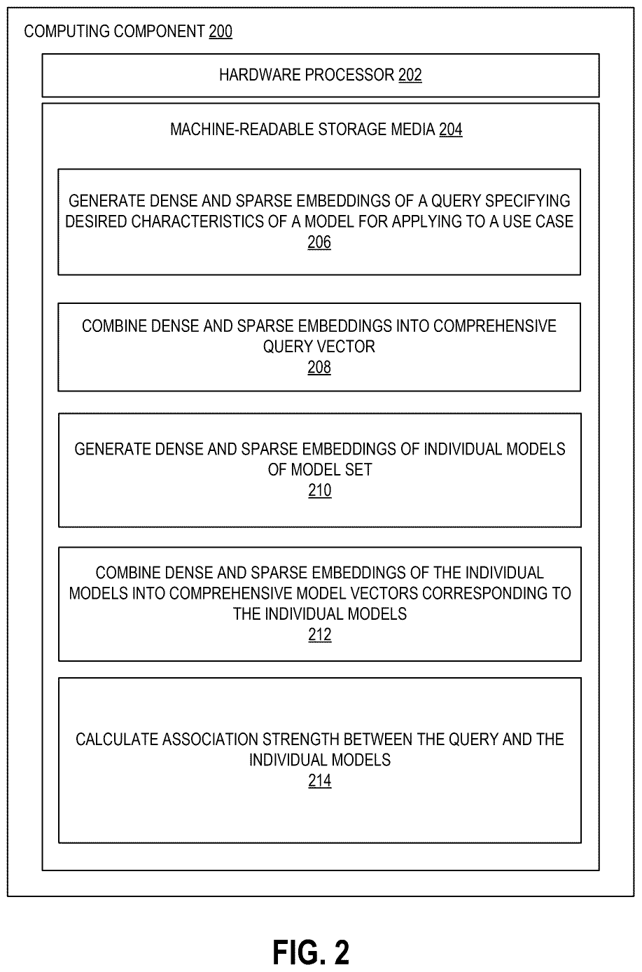

FIG. 2 illustrates a computing component that may be used to analyze a query, characterize a model, and/or relate the model and query to determine if the model may be suitable for satisfying the query in accordance with various examples of the disclosed technology. Referring now to FIG. 2, computing component 200 may be, for example, a server computer, a controller, or any other similar computing component capable of processing data. In the example implementation of FIG. 2, computing component 200 includes a hardware processor 202, and machine-readable storage medium 204.

Hardware processor 202 may be one or more central processing units (CPUs), semiconductor-based microprocessors, and/or other hardware devices suitable for retrieval and execution of instructions stored in machine-readable storage medium 204. Hardware processor 202 may fetch, decode, and execute instructions, such as instructions 206-214, to ultimately associate the model and query. As an alternative or in addition to retrieving and executing instructions, hardware processor 202 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 204, may be any electronic, magnetic, optical, or other physical storage device that contains or stores executable instructions. Thus, machine-readable storage medium 204 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 204 may be a non-transitory storage medium, where the term “non-transitory” does not encompass transitory propagating signals. As described in detail below, machine-readable storage medium 204 may be encoded with executable instructions, for example, instructions 206-214.

Hardware processor 202 may execute instruction 206 to generate dense and spare embeddings or encodings of a query specifying desired characteristics of a model for applying to a use case. As described herein, a user (single user, multi-person entity, etc.) may wish to determine an appropriate model, such as a foundational model, to use for one or more tasks or jobs, referred to as a use case. In order to analyze a query specifying desired characteristics of one or more models, the characteristics or needs of the use case, etc., a dense embedding (vector embedding) can be generated. In some examples, a word embedding model or other appropriate alternative may be used to generate the dense embedding. As noted above, in order to glean as much meaning from the query analysis, in addition to a dense embedding, a sparse embedding may also be generated. Known or future-discovered topic modeling or an LLM-based mechanisms or approaches can be used to extract relevant/important components of a query, such as a domain(s) (an area/field of use), one or more tasks, and other details that may be relevant to determining an appropriate model(s) to recommend. Such mechanisms/approaches can refine the query by extracting relevant/representative keywords from the query, adding contextual detail to the dense embedding.

For example, a user may input a natural language query stating “We need models for clinical note summarization, medical diagnosis assistance, and answering doctor questions about treatments. Models must handle medical terminology accurately, run efficiently on A100 GPU, and meet healthcare compliance standards.” It should be noted that any type/form of query may be input by a user, but even if natural language is used to specify the query, examples of the disclosed technology are able to glean the meaning/detail. In this example, where the query is a natural language query, a word embedding model, such as SenBERT, can be used to obtain the dense embedding regarding the following portion of the query, “We need models for clinical note summarization, medical diagnosis assistance, and answering doctor questions about treatments. Models must handle medical terminology accurately.” It should be understood that certain portions of a query may embody information appropriate for one or more embeddings. Here, this first portion of the query is appropriate for dense embedding, whereas the task constraints specified in the query (GPU/health compliance requirements) may be appropriate for sparse representation, although the embedding tool(s)/mechanism(s) can vary regarding what aspect(s) or a query can be used to generate an embedding. A dense embedding/vector, Qᵥ₁, can be generated. Specific requirements set forth in the query can be captured in a sparse vector, Qᵥ₂, which has specific entries for model parameters, e.g., single graphical processing unit (GPU), multi GPU, memory available, type of GPU, expected throughput, number of concurrent requests, and so on.

The sparse vector, Qᵥ₂, contains a value of 1 corresponding to the entries the user queries have. For example, the query can be represented by (1, 0, 1, 0, 0, 1, 0, 0, 0) if the vector indices correspond to (single GPU, multi GPU, A100 GPU, A40 GPU, V100 GPU, memory less than 50 GB, memory between 50 to 100 GB, throughput greater than 1 token per second, ethical concerns). Generally (in practice) the length of sparse vector, Qᵥ₂, is in the range of 100.

Hardware processor 202 may execute instruction 208 to combine the dense and sparse embeddings into a comprehensive (hybrid) query vector. This comprehensive vector may combine the dense and sparse embeddings. In an example, this combination can be obtained by concatenating Qᵥ₁ and Qᵥ₂. In an example, the length of this hybrid vector may be the sum of the length of the dense vector, and the length of the sparse vector. It should be understood that examples of the disclosed technology contemplate other known (now or in the future) manners to combining dense and sparse embeddings. In some examples, other dense and sparse representations may be leveraged, as well as other known (now or in the future) ways to combine or blend the representations.

Hardware processor may execute instruction 210 to generate dense and sparse embeddings of individual models of a model set. A model repository may comprise a set of models from which recommended models may be identified. Generating these embeddings allows the individual models to be characterized (where the characteristics can be used to associate the individual models to the query, i.e., determine how relevant or suitable the individual models are to the query). Both the dense and sparse embeddings can be encoded in the same representation space to streamline later operations. For example, models are characterized and their domains and other parameters are recorded in sparse and dense vectors. For example, a model such as a foundation model, Med42B, may have a dense representation vector obtained by computing word embeddings of the metadata characteristics (such as domain terms like medical, clinical, etc.) associated with the Med42B model. At the same time, the sparse representation or embedding is computed using its features, such as (0, 0, 0, 0, 0, 1, 0, 0, 0) as the same indices are used when generating the sparse embedding representative of the query (achieving encoding in the same representation space).

Hardware processor 202 may execute instruction 212 to combine the dense and sparse embeddings of the individual models into comprehensive model vectors corresponding to the individual models. As with the comprehensive query vector, the dense and sparse embeddings for an individual model can be concatenated to form a corresponding comprehensive model vector.

Hardware processor 202 may execute instruction 214 to calculate an association strength between the query and the individual models. The individual models are those from which potential models to be recommended are determined based on the comprehensive query vector and the comprehensive model vectors corresponding to the individual models. As described above, statistical methods or techniques, the use of lineage graphs, and other mechanisms for characterizing data can be used to enhance or augment the embedding-based association strength determinations performed in accordance with examples of the disclosed technology.

Until now, the query is represented by a hybrid/comprehensive vector containing dense and sparse embeddings, and each of the individual models is represented by a collection of dense (one for each metadata characteristic) and sparse embeddings. The dense part of the query is compared with each individual model's dense embedding vectors using cosine similarity. By fixing a threshold on a desired cosine similarity (e.g., 0.3), the number of metadata characteristics can be counted for each individual model that meets or passes this threshold. For example, model Med42 can have two metadata characteristics (medical and clinical) with a cosine similarity of more than 0.3 with the dense part of the query vector. Similarly, this number can be computed for the models. For each individual model, the similarity between their sparse embedding and the query's sparse embedding can be computed, resulting in the strength of model query association using both dense and sparse embeddings.

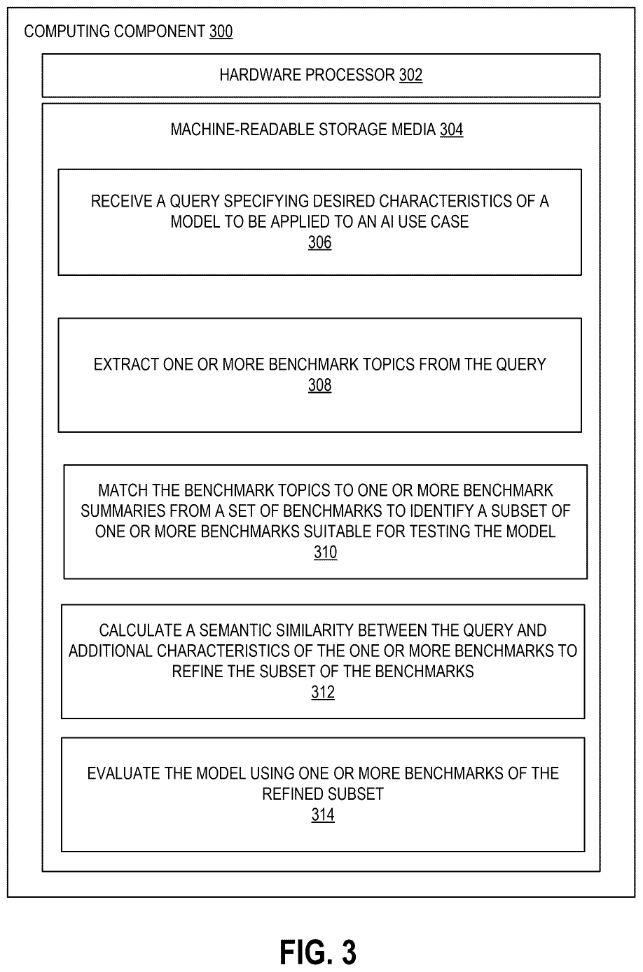

FIG. 3 illustrates a computing component that may be used to identify/recommend one or more benchmarks to be used for evaluating recommended model in accordance with various examples of the disclosed technology. Referring now to FIG. 3, computing component 300 (similar to computing component 200 of FIG. 2) may be, for example, a server computer, a controller, or any other similar computing component capable of processing data. In the example implementation of FIG. 3, computing component 300 includes a hardware processor 302 (like hardware processor 202), and machine-readable storage medium 304 (like machine-readable storage medium 204).

Hardware processor (or electronic circuit) 302 may fetch, decode, and execute instructions, such as instructions 306-314, to identify and recommend one or more benchmarks on which a recommended model is to be evaluated/tested. As described in detail below, machine-readable storage medium 304 may be encoded with executable instructions, for example, instructions 306-314.

Hardware processor 302 may execute instruction 306 to receive a query specifying desired characteristics of a model to be applied to an AI use case. Again, a user (single user, multi-person entity, etc.) may wish to determine an appropriate model, such as a foundational model, to use for one or more tasks or jobs, referred to as a use case. Following the above-described example (set forth in conjunction with the description of FIG. 2), the query can specify that an appropriate/desired model(s) “must handle medical terminology accurately, run efficiently on an A100 GPU, and meet healthcare compliance standards.”

Hardware processor 302 may execute instruction 308 to extract one or more benchmark topics from the query. As discussed above, topic modeling can be performed to extract benchmark topics, which can refer to defined problems or datasets used to evaluate the performance of a model. In some examples, topic modeling can comprise performing statistical modeling using, e.g., unsupervised ML techniques to identify clusters or groups of similar words present in the query. In this way, the query can be interpreted to determine what bookmarks would be appropriate for testing or evaluating a desired model as characterized by the query.

Hardware processor 302 may execute instruction 310 to match the benchmark topic(s) to one or more benchmark summaries from a set of benchmarks to identify a subset of one or more benchmarks suitable for testing the model. That is, examples of the disclosed technology via, e.g., benchmark information extraction module 118B (FIG. 1) may summarize benchmarks using representative samples. Benchmark repositories, such as that containing the set of the benchmarks may comprise, in part, information that characterizes the benchmark, such as a benchmark dashboard that sets forth characteristics of the benchmark. Such information can include, but is not limited to, benchmark results regarding the performance of models tested on the benchmark. As noted above, benchmarks may comprise standardized datasets and evaluation frameworks used to assess the performance of a model on specific tasks or capabilities. Summaries of samples of data (of the standardized datasets) can be generated to characterize the benchmark, i.e., performance information of models when tested on the benchmark. The one or more benchmark topics and the benchmark summaries can be input into an LLM that performs an analysis to determine whether the benchmark's performance on the model (other models) would be suitable for testing model in accordance with the extracted benchmark topics.

In some examples, hardware processor 302 may execute instruction 312 to calculate a semantic similarity between the query and additional characteristics of the one or more benchmarks to refine the subset of the benchmarks suitable for testing the mode. That is, a selection of benchmarks determined as a result of the benchmark topic(s)-to-benchmark summary matching can be refined by calculating the semantic similarity between benchmark descriptions (gleaned from, e.g., a benchmark dashboard of the benchmark repository), the benchmark samples/summaries, and the query. This process operates by first identifying, at a high level, possible suitable benchmarks for testing the model. Then, the process further filters the first-identified benchmarks based on semantic similarity to reduce the number of possible suitable benchmarks, saving the compute/time cost that would have been incurred by testing more benchmarks. From these operations, a “final” set or subset of benchmarks may be identified/recommended for use in testing one or more recommended models.

Hardware processor 302 may execute instruction 314 to evaluate the model using one or more benchmarks of the refined subset. Model evaluation using one or more recommended benchmarks may comprise running the model on the one or more benchmarks. As noted above, the one or more benchmarks may comprise a standardized dataset and evaluation framework used to assess the performance of the model on specific tasks or capabilities. A benchmark typically comprises or involves an automated process by which the model is tested per the benchmark, resulting in some qualitative score, rank, or other assessment.

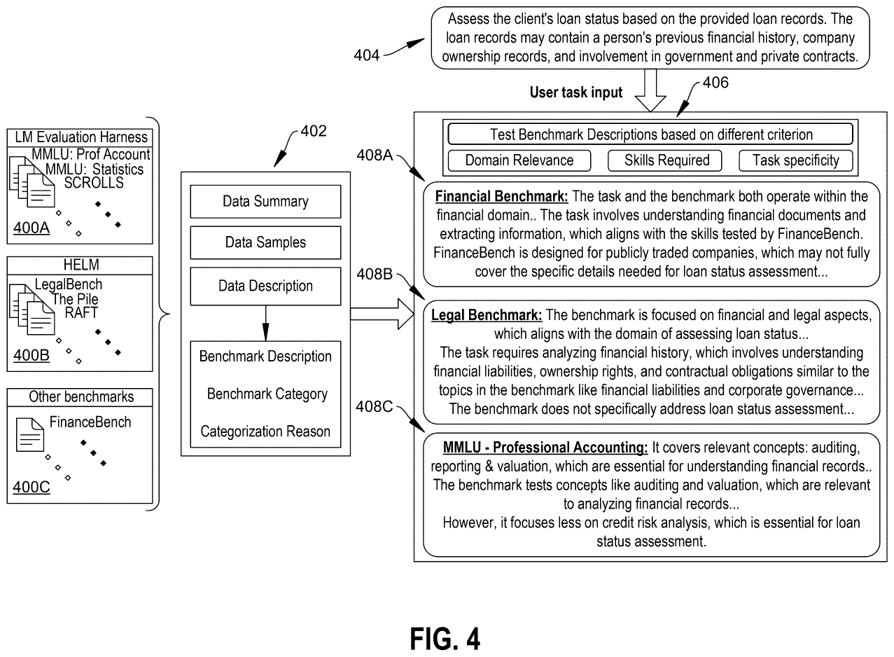

FIG. 4 illustrates an example method of determining one or more benchmarks to recommend for testing one or more models in accordance with some examples of the disclosed technology. As illustrated in FIG. 4, a set of benchmarks from which one or more suitable benchmarks for testing a model can be set forth in one or more benchmark repositories. One or more benchmarks 400A-400C from one or more benchmark sources/repositories can be taken into consideration by recommendation engine 120 (FIG. 1). For example, in this scenario, sets of possible benchmarks 400A-400C may include Massive Multitask Language Understanding (MMLU) benchmarks regarding professional accounting, statistics, and a Standardized CompaRison Over Long Language Sequences (SCROLLS) benchmark from a language model evaluation harness (an example model repository LM evaluation framework). Benchmarks 400B may include a legal reasoning benchmark which can be referred to, e.g., as “Legal Benchmark,” “the Pile,” an LM training dataset, and a model tuning framework, RAFT, which can refer to Reward rAnked Fine Tuning. Still other benchmarks may be leveraged, e.g., benchmark 400C, which in this scenario may be a financial-relevant benchmark, which can be referred to, e.g., as “Financial Benchmark.”

As noted above, certain information, such as metadata, 402 associated with a given benchmark can be used to characterize the benchmark so that a determination can be made as to whether or not the given benchmark would be suitable for testing a given model. In some examples, a benchmark (data) summary can be generated from data samples of the benchmark dataset (and possibly descriptions of the benchmark dataset if available), and additional benchmark-related information. This additional benchmark-related information may include, but is not limited to, e.g., a benchmark description, a categorization of a benchmark, categorization reason, and so on.

The benchmark-related information can be compared with benchmark topics extracted from a query, such as query 404, to obtain a first/initial set or subset of benchmarks that may be suitable for testing a model. Benchmark recommendation engine 120B of FIG. 1 may be configured to calculate semantic similarities between query 404 and the benchmark characteristics 402. Such semantic similarity determinations 406 can be based on, e.g., the benchmark descriptions based on different criteria, relevance to a stated domain, required skills, and one or more specified tasks. Upon performing this semantic similarity determinations, one or more benchmarks 408 can be recommended for use in evaluating the model. In this example, a first benchmark 408A (Financial Benchmark) from the set of benchmarks 400A may be determined to be suitable, and thus, may be analyzed or processed. That is, benchmark recommendation engine module 120B (FIG. 1) may determine that the terms/phrases “both operate within the financial domain,” and “aligns with the skills tested,” may suggest relevance to the query. In contrast, the phrase “may not fully cover the specific details,” may weigh to disfavor recommendation of benchmark 408A. Regarding second benchmark 408B (Legal Benchmark), relevant context in its description/metadata can include the phrases, “aligns with the domain,” and “similar to the topics in the benchmark,” and “does not specifically address loan status assessment,” which can be considered when determining whether or not second benchmark 408B should be recommended for testing a model. Regarding a third benchmark 408C, the terms/phrases “covers relevant concepts,” and “relevant to analyzing financial records” may be considered as weighing in favor of recommendation, whereas “focuses less on credit risk analysis,” may weight to disfavor a recommendation given that the query 404 specifies “loan status,” and “loan records.” As noted above, benchmark-related information can be compared with benchmark topics extracted from a query, such as query 404, to obtain a first/initial set or subset of benchmarks that may be suitable for testing a model. Benchmark recommendation engine 120B of FIG. 1 may also be configured to then, calculate semantic similarities between query 404 and the benchmark characteristics 402.

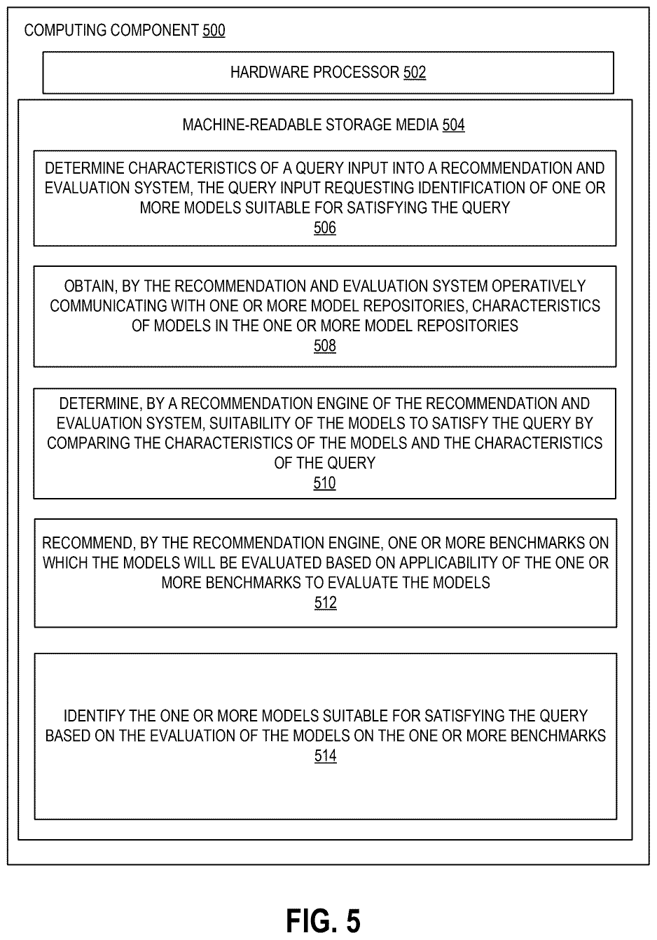

FIG. 5 illustrates a computing component that may be used to achieve co-optimized model recommendation and evaluation in accordance with various examples of the disclosed technology. Referring now to FIG. 5, computing component 500 (similar to computing components 200/300 of FIGS. 2/3) may be, for example, a server computer, a controller, or any other similar computing component capable of processing data. In the example implementation of FIG. 5, computing component 500 includes a hardware processor 502 (like hardware processors 202/302), and machine-readable storage medium 504 (like machine-readable storage mediums 204/304).

Hardware processor (or electronic circuit) 502 may fetch, decode, and execute instructions, such as instructions 506-514, to recommend and evaluate one or more models for application to a use case. As described in detail below, machine-readable storage medium 504 may be encoded with executable instructions, for example, instructions 506-514.

Hardware processor 502 may execute instruction 506 to determine characteristics of a query input into a recommendation and evaluation system requesting identification of one or more models suitable for satisfying the query. For example, a query input into a recommendation and evaluation system requesting one or more models suitable for satisfying the query can be analyzed. A user may input a query in natural language (or other format) into a front-end UI to a recommendation and evaluation system, such as recommendation and evaluation system 100 of FIG. 1. The query can specify desired characteristics of a suitable model, constraints, a use case to which the suitable model is to be applied, and so on. A query processing layer can generate dense and sparse embeddings from the query, and then combine the dense and sparse embeddings to create a comprehensive or hybrid vector embedding representation of the query. This hybrid or comprehensive vector embedding of the query can be used later to determine whether or not a model might be suitable for satisfying the query.

Hardware processor 502 may execute instruction 508 to obtain, by the recommendation and evaluation system operatively communicating with one or more model repositories, characteristics of models that are possibly suitable for satisfying the query. Similar to the manner in which the query may be characterized, the models of a set of models (some or all of the models) maintained in the model repository can be characterized by generating a hybrid vector embedding of the models. In this way, models' characteristics can be compared to those of the query to determine suitability of one or more models to satisfy the query, and ultimately be applied to the use case. The hybrid vector embedding is generated in the same representation space to allow for this comparison.

Hardware processor 502 may execute instruction 510 to determine, by a recommendation engine of the recommendation and evaluation system, suitability of the models to satisfy the query by comparing the characteristics of the models and the characteristics of the query. The suitability can be determined by calculating the similarity between characteristics of the models and those of the query using similarly techniques, such as cosine similarity. The strength of similarity between a model and the query (also referred to herein as association strength) relative to a threshold can then be used to judge whether or not a model may be suitable for satisfying the query (and subsequently evaluated using recommended bookmarks). Those models whose strength of similarity neither meets nor exceeds the threshold can be “discarded” from consideration.

Hardware processor 502 may execute instruction 512 to recommend, by the recommendation engine, one or more benchmarks on which the models will be evaluated based on applicability of the or more benchmarks to evaluate the models. Benchmarks from a benchmark repository can be characterized by summarizing representative data samples associated with testing using the benchmarks. Such summaries, along with benchmark topics extracted from any benchmarking or testing/model performance requirements set forth in the query, can be analyzed to determine their similarity with one another. Semantic similarity analysis can be performed as well to further refine the set of possibly suitable benchmarks to arrive at a “final” set or subset of benchmark recommendations (i.e., one or more benchmarks deemed to be suitable for testing one or more recommended models).

Hardware processor 502 may execute instruction 514 to identify the one or more models suitable for application to the use case based on the evaluation of the models on the one or more benchmarks. As described herein, those models that may be suitable to satisfy the query can be evaluated or tested on one or more benchmarks recommended for evaluating/testing the models. It should be understood that selection of appropriate benchmarks on which models are to be tested can have a significant impact on performance. That is, using an inappropriate benchmark to test a model would likely result in the model performing poorly (e.g., because the benchmark is not made to evaluate the model, e.g., the model and benchmark are associated with different domains, or the parameters of a benchmark may not coincide with predictive features of the model, and so on). Basing or judging a model's performance on an evaluation over over an inappropriate benchmark would be detrimental because the results of the evaluation would not be truly indicative of the model's (intended) performance. Evaluation can be performed by running a model on the data set forth/specified by a recommended benchmark, and assessing the model's performance/determination on the recommended benchmark test data.

By iteratively refining recommendations and evaluations of models, examples of the disclosed technology are able to achieve efficient and accurate identification of suitable models and benchmarks. Moreover, as more use cases are executed, more targeted evaluations are computed using recommended models and bookmarks, and more per-model/benchmark performance matrices or metrics can be obtained, making the calculation for recommendation scores more accurate.

As described herein, model recommendation can follow a two-phase approach, where models can first be selected form a large pool of models (coarse-level model selection) by matching user-define use case parameters to models of the large pool. This can result in rapidly filtering, e.g., thousands of candidate models to a more manageable subsect, e.g., on the order of 10-20 models based on model characteristics (e.g., domain relevance, training data, architecture, and resource requirements). Given hardware constraints (e.g., four servers with 8×H100 GPUS), a recommendation and evaluation system configured in accordance with examples of the disclosed technology can first identify an optimal subset of models to deploy. This optimal subset can be determined by analyzing metadata characteristics that match domain constraints, considering model size and resource usage to optimize serving capacity, as well as performing optimization for diversity in model capabilities/sizes (e.g., a 70B model for complex tasks, and multiple 7B models for simpler tasks). Fine-grained filtering can be achieved using, e.g., LLMs, for more semantically similar-relevant determinations between models and the query.

Because examples of the disclosed technology limit the universe of models under consideration beforehand, compute and hosting constraints can be mitigated. Moreover, domain-relevance can be determined, allowing models to first be domain-relevant prior to recommending. Further still, examples of the disclosed technology are not reliant on historical training information/results, newly-released models can be taken into consideration through the use of various characterizations discussed herein.

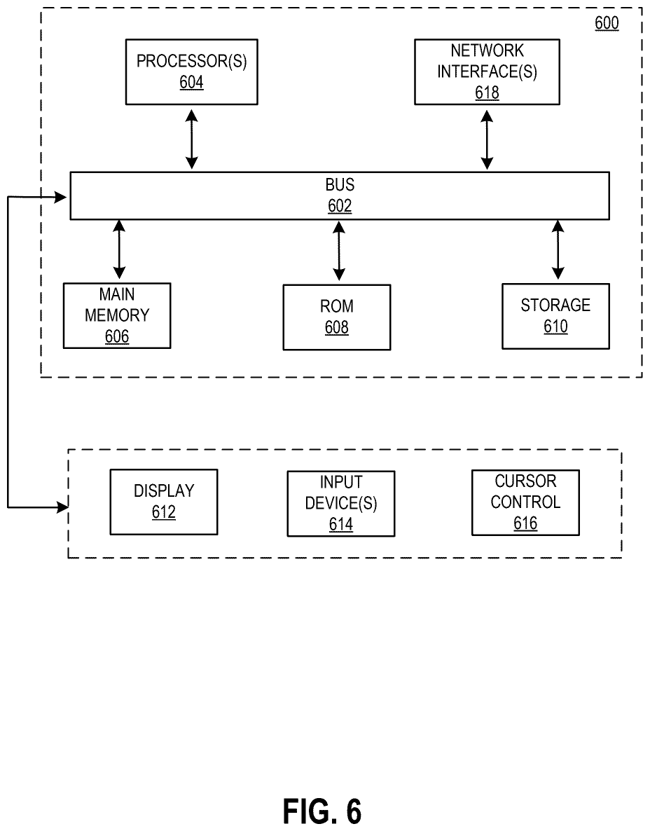

FIG. 6 depicts a block diagram of an example computer system 600 in which various examples of the disclosed technology described herein may be implemented. The computer system 600 includes a bus 602 or other communication mechanism for communicating information, one or more hardware processors 604 coupled with bus 602 for processing information. Hardware processor(s) 604 may be, for example, one or more general purpose microprocessors.

The computer system 600 also includes a main memory 606, such as a random access memory (RAM), cache and/or other dynamic storage devices, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

The computer system 600 further includes a read only memory (ROM) 608 or other static storage device coupled to bus 602 for storing static information and instructions for processor 604. A storage device 610, such as a magnetic disk, optical disk, or USB thumb drive (Flash drive), etc., is provided and coupled to bus 602 for storing information and instructions.

The computer system 600 may be coupled via bus 602 to a display 612, such as a liquid crystal display (LCD) (or touch screen), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. In some examples, the same direction information and command selections as cursor control may be implemented via receiving touches on a touch screen without a cursor.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts.

The computer system 600 may implement the techniques described herein using customized hard-wired logic, one or more ASICs or FPGAs, firmware and/or program logic which in combination with the computer system causes or programs computer system 600 to be a special-purpose machine. According to one example of the disclosed technology, the techniques herein are performed by computer system 600 in response to processor(s) 604 executing one or more sequences of one or more instructions contained in main memory 606. Execution of the sequences of instructions contained in main memory 606 causes processor(s) 604 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-transitory media is distinct from but may be used in conjunction with transmission media. Transmission media participates in transferring information between non-transitory media. For example, transmission media includes coaxial cables, copper wire and fiber optics, including the wires that comprise bus 602. Transmission media can also take the form of acoustic or light waves, such as those generated during radio-wave and infra-red data communications.

The computer system 600 also includes a communication interface 618 coupled to bus 602. Network interface 618 provides a two-way data communication coupling to one or more network links that are connected to one or more local networks. For example, communication interface 618 may be an integrated services digital network (ISDN) card, cable modem, satellite modem, or a modem to provide a data communication connection to a corresponding type of telephone line. As another example, network interface 618 may be a local area network (LAN) card to provide a data communication connection to a compatible LAN (or WAN component to communicated with a WAN). Wireless links may also be implemented. In any such implementation, network interface 618 sends and receives electrical, electromagnetic or optical signals that carry digital data streams representing various types of information.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS).

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
determining characteristics of a query input into a recommendation and evaluation system, the query input requesting identification of one or more models suitable for satisfying the query;
obtaining, by the recommendation and evaluation system operatively communicating with one or more model repositories, characteristics of models in the one or more model repositories;
determining, by a recommendation engine of the recommendation and evaluation system, suitability of the models to satisfy the query by comparing the characteristics of the models and the characteristics of the query;
recommending, by the recommendation engine, one or more benchmarks on which the models will be evaluated based on applicability of the one or more benchmarks to evaluate the models;
identifying the one or more models suitable for satisfying the query based on the evaluation of the models on the one or more benchmarks.

2. The method of claim 1, wherein determining the characteristics of the query comprise generating a dense embedding representative of the query and a sparse embedding representative of the query.

3. The method of claim 2, further comprising generating the sparse embedding representative of the query based on at least one of topic modeling and large language model (LLM)-based analysis of the query.

4. The method of claim 2, further comprising generating a comprehensive query vector by combining the dense embedding representative of the query and the sparse embedding representative of the query.

5. The method of claim 1, wherein determining the characteristics of the models comprises generating dense embeddings representative of the models and sparse embeddings representative of the models.

6. The method of claim 5, further comprising generating hybrid characteristics vectors representative of the models by combining the dense embeddings representative of the models and the sparse embeddings representative of the models.

7. The method of claim 1, wherein the comparing of the characteristics of the models and the characteristics of the query comprises determining an association strength between the query and the models based on calculated similarities between the models and the characteristics of the query.

8. The method of claim 7, wherein determining the association strength further comprises extending the characteristics of the models based on additional information obtained by at least one of statistical methods and lineage graphs.

9. The method of claim 1, wherein the recommending of the one or more benchmarks comprises extracting benchmark topics from the benchmark repository, summarizing the one or more benchmarks, and inputting the benchmark topics and the summaries into an LLM for suitability analysis.

10. The method of claim 9, further comprising determining a semantic similarity between the query and the one or more benchmarks based on the summaries, descriptions of the one or more benchmarks.

11. The method of claim 1, further comprising persisting the models from the one or more model repositories in a model memory of the recommendation and evaluation system.

12. The method of claim 11, further comprising invoking application programming interface (API) calls between the recommendation and evaluation system and the one or more model repositories to download the models of the one or more model repositories to be persisted in the model memory.

13. The method of claim 1, further comprising persisting information regarding the evaluation of the models in a model evaluation memory of the recommendation and evaluation system for use in at least one of the identifying of the one or more models suitable for satisfying the query and identifying one or more models suitable for satisfying one or more future queries.

14. A system, comprising:
a processor; and
a memory operatively connected to the processor and including computer code that when executed, causes the processor to:
generate dense and sparse embeddings of a query specifying desired characteristics of a model for applying to a use case;
combine the dense and spare embeddings into a comprehensive query vector;
generate dense and sparse embeddings of individual models of a model set;
combine the dense and sparse embeddings of the individual models into comprehensive model vectors corresponding to the individual models; and
calculate association strengths between the query and the individual models.

15. The system of claim 14, wherein the dense embedding comprises a word embedding of the query, and wherein the sparse embedding comprises one of a topic-based embedding or a large language model (LLM)-generated embedding.

16. The system of claim 14, wherein the memory comprises further instructions that when executed, further cause the processor to encode the dense and sparse embeddings of the individual models in the same representation space.

17. A computer-implemented method, comprising:
receiving a query specifying desired characteristics of a model to be applied to an artificial intelligence (AI) use case;
extracting one or more benchmark topics from the query;
matching the benchmark topics to one or more benchmark summaries from a set of benchmarks to identify a subset of one or more benchmarks suitable for testing the model;
calculating a semantic similarity between the query and additional characteristics of the one or more benchmarks to refine the subset of the benchmarks; and
evaluating the model using the one or more benchmarks of the refined subset.

18. The computer-implemented method of claim 17, wherein the extracting of the one or more benchmark topics comprises performing topic model using unsupervised AI models to identify clusters of words of the query to identify semantic structures indicative of a meaning of the query.

19. The computer-implemented method of claim 17, further comprising persisting information regarding the evaluation of the model in an evaluation memory for generating one or more model recommendations to satisfy at least one of query and one or more future queries.

20. The computer-implemented method of claim 19, further comprising updating information regarding the model in a model repository with the information regarding the evaluation of the model.
